(19) United States
(12) Patent Application Publication
(10) Pub. No.: US 2010/0192738 A1
(43) Pub. Date: Aug. 5, 2010

(54) TOOL WITH INTERCHANGEABLE WORK HEADS

(76) Inventor: Daniel P. Fenstemaker, Paris, OH (US)

Correspondence Address: FRED ZOLLINGER III, P.O. BOX 2368, NORTH CANTON, OH, 44720, US

(21) Appl. No.: 12/572,920

(22) Filed: Oct. 2, 2009

Related U.S. Application Data
(60) Provisional application No. 61/102,272, filed on Oct. 2, 2008.
(60) Provisional application No. 61/147,312, filed on Jan. 26, 2009.
(60) Provisional application No. 61/173,587, filed on Apr. 28, 2009.

(51) Int. Cl. B25G 1/00

(52) U.S. Cl. 81/489

(57) ABSTRACT

A construction-grade hand tool has interchangeable tool heads that can withstand significant impact, pulling, and twisting forces. The tool heads may include a shovel, a rake, a hoe, a bow saw, a broom, a fork, pruning shears, and other construction and fire fighting tool heads. A tool head adapter securely connects these tool work heads to a handle which may be a telescoping handle. The tool head adapter is connected to the tool head in a manner that provides a strong, impact-resistant connection between the adapter and the tool head. The handle may include a shock absorber structure. The adapter is configured to be securely and tightly received by a clamping and/or quick-release receptacle on the end of the handle.

### CROSS REFERENCE TO RELATED APPLICATIONS

This application claims the benefit of U.S. provisional applications 61/102,272 filed Oct. 2, 2008, 61/147,312 filed Jan. 26, 2009, and 61/173,587 filed Apr. 28, 2009; the disclosures of each are incorporated herein by reference.

### BACKGROUND OF THE INVENTION

1. Technical Field

The invention generally relates to hand tools and, more particularly, to a hand tool with interchangeable work heads and telescoping handles. Specifically, the invention relates to construction-grade hand tools having interchangeable work heads with adapters designed to maintain a secure connection between the work head and the handle that can withstand the impact, twisting, and pulling forces imparted on construction-grade tools.

2. Background Information

Shovels, rakes, hoes and the like have been made non-interchangeable with wooden, non-telescopic handles for thousands of years. More recent versions of such tools have handles made of steel, aluminum, or fiberglass. Tools with interchangeable work heads are also known in the art. Those in the construction industry, landscaping, and fire fighting professions desire tools that can withstand extreme working conditions wherein significant impact, pulling, and twisting forces are imparted on the tools during their normal use. Users of this type have generally not adopted tools with interchangeable work heads because the tools have not been designed for heavy work and significant forces. Workers in the fire fighting industry wish to have multiple tools in a mobile package.

### SUMMARY OF THE INVENTION

The invention provides a construction-grade hand tool having interchangeable work heads that can withstand significant impact, pulling, and twisting forces. The work heads can be quickly interchanged. As such, one configuration of the invention provides a professional-grade hand tool that includes a plurality of tool work heads; each of the tool work heads being connected to a tool head adapter; a telescoping handle having a tool head adapter locking mechanism; and each of the plurality of tool work heads being interchangeably lockable to the telescoping handle with the tool head adapter locking mechanism. The work heads may include a shovel, a rake, a hoe, a bow saw, a broom, a fork, pruning shears, and other construction and fire fighting tool work heads. The invention provides a tool head adapter that securely connects these tool work heads to a handle which may be a telescoping handle. The tool head adapter is connected to the tool work head in a manner that provides a strong, impact-resistant connection between the adapter and the tool work head. These connections may be welds, pins, bolts, screws, or interference fits as dictated by the type of work head being used. The other end of the adapter is configured to be securely and tightly received by a clamping and/or quick-release receptacle on the end of the handle.

The invention provides an adapter is configured to prevent the tool work head from rotating when the tool work head is secured to the handle. In one configuration, the adapter includes a cylindrical male shank that is received in a female receptacle carried by the handle. The female receptacle has a rotational clamping member that clamps onto the male shank to provide a secure connection between the tool handle and the tool work head.

In one configuration, the invention provides an adapter having a combined rotational clamping and push button locking features. In one configuration, the tool head adapter includes a recess that receives an end of a pivoting locking member carried by the handle. The pivoting locking member adds a secondary secure locking connection between the handle and the tool work head. In another configuration, the user choose to not use the clamping mechanism and simply use the pivoting locking member to hold the tool work head to the handle. This option is useful for some tool work heads. In still another configuration, the pivoting locking member may be provided without the clamping member.

The invention also provides a hand tool having a handle with an internal shock absorbing member that receives and buffers longitudinal impact forces received by the tool work head. In one configuration, the shock absorbing member is a structure disposed inside the handle tube closest to the tool adapter with adapter abutting one end of the structure and the other end of the structure abutting the device that clamps the handle tubes together.

The invention provides such a tool with a telescoping handle having tubular fiberglass handle sections. The handle may be configured to provide handle adjustments of 2-4 feet, 4-8 feet, 6-12 feet, and 8-16 feet.

The invention provides a kit having a hand tool that itself includes a plurality of interchangeable work heads and a telescoping handle that all fit within a pack adapted to be carried by a single person. The kit also may include a second telescoping handle. This kit allows the user to readily transport a variety of construction grade tools to a remote location while walking.

In one configuration, the invention provides a hand tool that includes a tool work head; a tool head adapter having a first shank and a second shank with a shoulder defined between the first and second shanks; the tool head adapter being connected to the tool work head; a handle having a tool head adapter locking mechanism carried by an inner tube; a shock absorbing structure disposed inside the inner tube; the shock absorbing structure defining an opening; the second shank of the adapter disposed in the opening defined by the shock absorbing structure; at least a portion of the first shank being disposed inside the inner tube; the shoulder of the adapter abutting the shock absorbing member; and the tool head adapter locking mechanism having a clamped configuration and an unclamped configuration; a portion of the tool head adapter locking mechanism surrounding a clamping portion of the first shank of the adapter and being clamped against the clamping portion of the first shank of the adapter to secure the tool head adapter to the inner tube.

Another configuration of the invention provides a hand tool that includes a tool work head; a tool head adapter having a first shank and a second shank with a shoulder defined between the first and second shanks; the tool head adapter being connected to the tool work head; a handle having a tool head adapter locking mechanism carried by an inner tube; the first and second shanks of the tool head being frictionally received by the handle with the shoulder abutting a portion of the handle; and the tool head adapter locking mechanism having a clamped configuration and an unclamped configuration; a portion of the tool head adapter locking mechanism surrounding a clamping portion of the first shank of the adapter and being clamped against the clamping portion of the first shank of the adapter to secure the tool head adapter to the inner tube.

### BRIEF DESCRIPTION OF THE DRAWINGS

FIG. 1 is a side elevation view of the handle.

FIGS. 2A-2C show three different tool work heads secured to tool head adapters.

FIG. 3A is a section view taken along line 3A-3A of FIG. 1.

FIG. 3B is a section view taken along line 3B-3B of FIG. 1.

FIG. 3C is a section view taken along line 3C-3C of FIG. 1.

FIG. 4 is a section view similar to FIG. 3A depicting an alternative configuration for the adapter locking mechanism.

FIGS. 5A-5H depict a variety of configurations for the tool head adapter.

Similar numbers refer to similar parts throughout the specification.

### DETAILED DESCRIPTION OF THE INVENTION

An exemplary configuration of the tool of the invention generally includes a handle 4, a tool head adapter 6, and at least one tool work head 8. Tool may be configured for a wide variety of jobs by removing one tool work head 8 and replacing it with a different tool work head 8. An adapter locking mechanism 10 is used to secure tool head adapter 6 to handle 4 in a manner that allows the tool to withstand substantial forces associated with a construction-grade tool. Tool work heads 8 may include a shovel, a rake, a hoe, a bow saw, a broom, a fork, pruning shears, and other construction and fire fighting tool work heads.

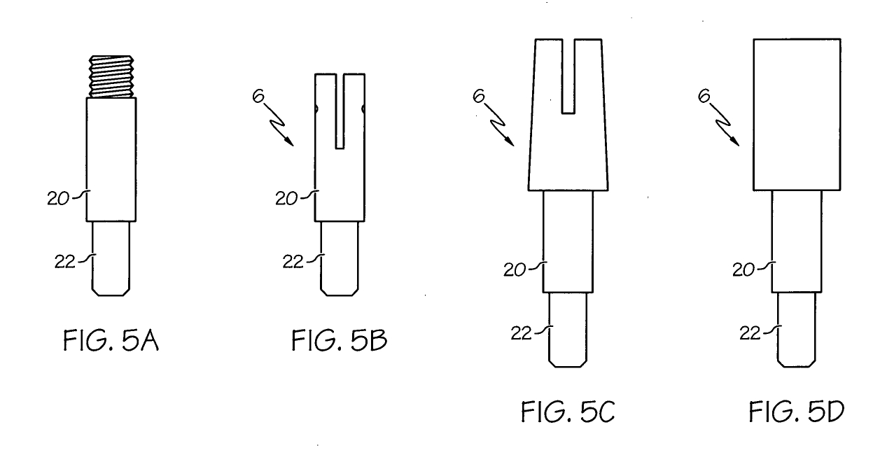

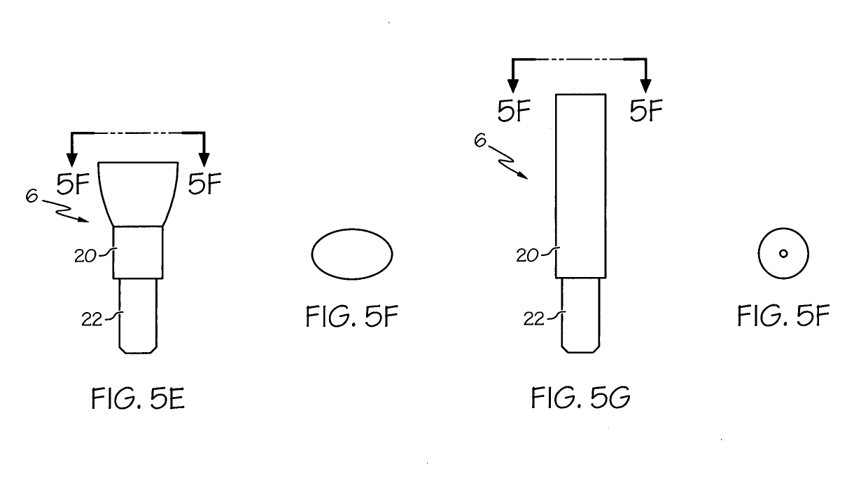

Tool head adapter 6 includes first 20 and second 22 shanks wherein second shank 22 is stepped down from first shank 20. In the exemplary configuration, first 20 and second 22 shanks have circular cross sections with the diameter of second shank 22 being smaller than the diameter of first shank 20. First shank 20 has a diameter of one inch while second shank 22 has a diameter of three-quarter inch. A shoulder 24 is defined between shanks 20 and 22. Shoulder 24 is disposed at a right angle to the longitudinal dimension of adapter 6. Tool head adapter 6 may be configured for a variety of different tool work heads 8 as shown in FIGS. 5A-5H. FIG. 5A depicts first shank 20 connected to a standard thread used to connect tool work head 8. FIG. 5B depicts a structure defining a slot configured to receive a portion of a saw blade. FIG. 5C depicts an adapter structure having a tapered end that may be used with a shovel. FIG. 5D depicts another configuration of adapter 6 having an elongated shank designed to fit into an opening of a tool work head 8. FIGS. 5E-5F depict an adapter 6 having an oval shank configured to be used with a sledgehammer, pick, mattock, or an axe. FIGS. 5G-5H depict an adapter configuration having a hole configured to receive an elongated shank such as that on a leaf rake.

The end of second shank 22 is beveled to assist in the insertion of adapter 6 into the end of handle 4. Second shank 22 may define an optional bore 26 that reduces the weight of adapter 6.

A clamping portion of the outer surface of first shank 20 of tool head adapter 6 is knurled 28, grooved, or otherwise textured to improve the frictional connection between handle 4 and adapter 6. Tool head adapter 6 is made from steel in the exemplary configuration but also may be made from aluminum, plastic, ceramic, or other hard materials.

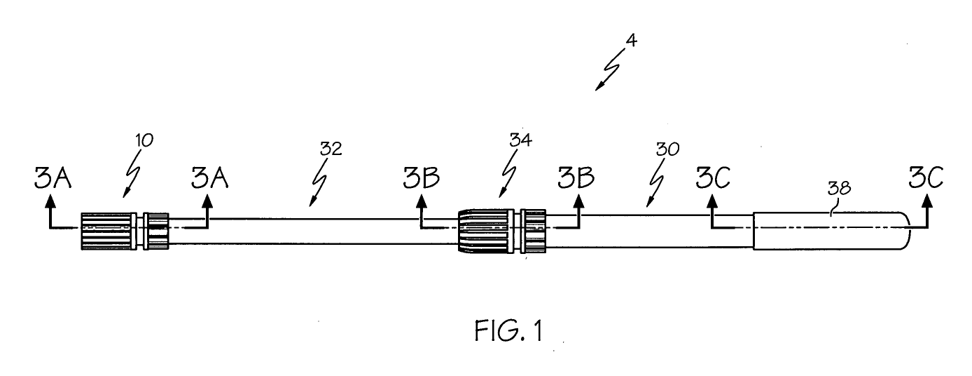

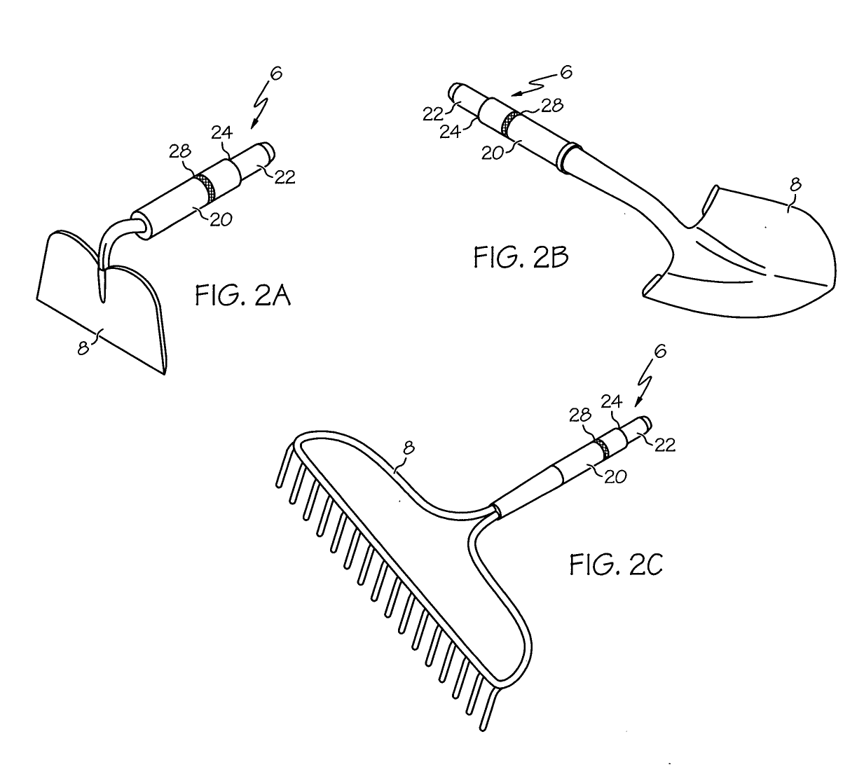

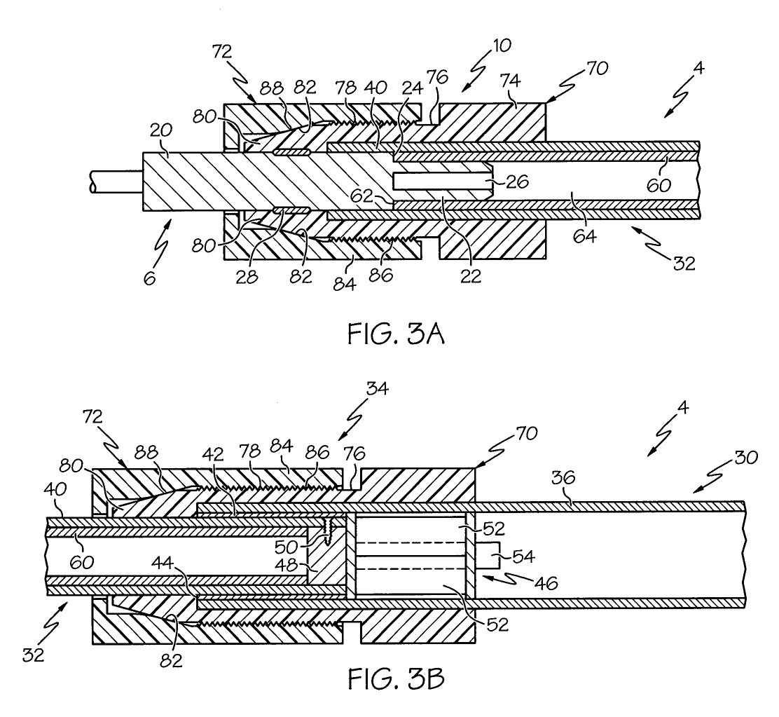

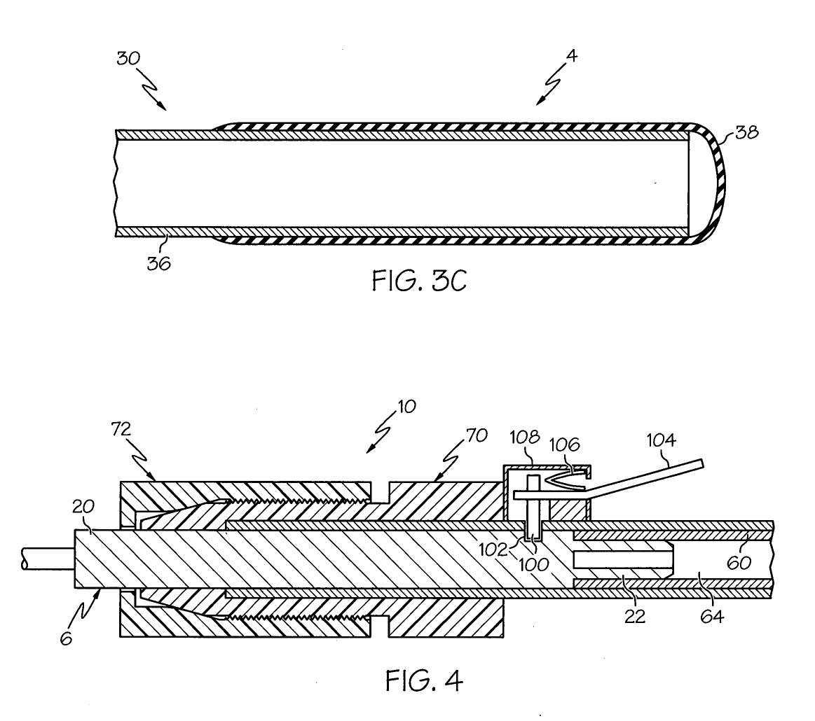

In a basic form, handle 4 includes a single non-telescoping tube section configured to receive tool head adapter 6. When a single tube section is used, the locking components depicted in FIG. 3B are not used. In some applications, handle 4 is configured to selectively telescope such that it may be adjusted different lengths and be locked at those lengths by the user. In the telescoping configuration, handle 4 generally includes an outer tube section 30 and an inner tube section 32 that slides at least partially into outer tube section 30 when the user unlocks a handle locking assembly 34. Handle locking assembly 34 may be used to configure the length of handle 4 at essentially any length between a minimum length dimension and a maximum length dimension. Handle 4 also includes adapter locking assembly 10 that selectively secures adapter 6 to the distal end of handle 4. Although FIG. 1 depicts only inner 32 and outer 30 tube sections, handle 4 may be provided with one or more intermediate tube sections that each telescope as described above and are each locked by a locking assembly similar to handle locking assembly 34. When an intermediate tube section is used, inner tube section 32 slides into the intermediate tube section and the intermediate tube section slides into outer tube section 30. Exemplary handles 4 may be configured to provide handle adjustments of 2-4 feet, 4-8 feet, 6-12 feet, and 8-16 feet. The collapsed condition of handle 4 allows handle 4 to be carried in a pack (backpack, gunny sack, duffel bag) with a plurality of tool heads 8. This kit of the pack, handle 4, and heads 8 may be readily carried to remote locations by a single person allowing the person to have access to multiple tools at the remote location.

Outer tube section 30 includes an outer tube 36 having a circular tubular cross section. Outer tube 36 may be made from fiberglass or other materials such as metal, plastics, or composites. In the exemplary configuration, outer tube 36 is a one and a half inch outer diameter fiberglass tube with a wall thickness of less than one eighth of an inch so that a one and one quarter inch outer diameter inner tube 40 may slide inside outer tube 36. Outer tube 36 has an outer skin and an inner skin with a corrugated or honeycombed inner layer so that tube 36 is light for its strength. The end of outer tube 36 opposite handle locking assembly 34 is at least partially wrapped by a grip 38. Grip 38 may be a rubber sleeve that is adhesively connected to the outer surface of outer tube 36.

Inner tube section 32 includes an inner tube 40 that extends between handle locking assembly 34 and adapter locking assembly 10. Inner tube 40 has an outer skin and an inner skin with a corrugated or honeycombed inner layer so that tube 36 is light weight for its strength. As shown in FIG. 3A, the first end of inner tube 40 receives at least a portion of first shank 20 and the entire second shank 22 to form a secure connection between handle 4 and adapter 6.

The second end of inner tube 40 is disposed inside outer tube 36. A sleeve 42 is disposed around and is secured to a portion of the second end of inner tube 40. Sleeve 42 may be secured to inner tube 40 with an adhesive. Sleeve 42 does not have to be continuous. An alternative to the continuous structure of sleeve 42 is a plurality of material strips 42. Sleeve 42 allows inner tube section 32 to slide back and forth within outer tube 36 without binding. The first end 44 of sleeve 42 abuts handle locking assembly 34 to stop inner tube section 32 in its extended position as shown in FIG. 3B.

The second end of inner tube 40 is connected to an expandable locking mechanism 46 that selectively locks inner tube 40 to outer tube 36 by when it is selectively expanded to a locked condition. Expandable locking mechanism 46 includes a mounting block 48 disposed inside the second end of inner tube 40. A mechanical connected 50 is used to secure inner tube 40 to mounting block 48. Connector 50 also may be used to help secure sleeve 42 to inner tube 40. Expandable locking mechanism 46 includes a pair of shoes 52 that expand outwardly when a cam 54 is rotated to a locked position. Cam 54 is an elongated member disposed between shoes 52 and engages cam follower portions of shoes 52 to push shoes 52 outwardly when cam 54 is rotated. Shoes 52 have elastomeric gripping surfaces that engage the inner surface of outer tube 36. Cam 54 is connected to and rotates with mounting block 48 so that the user of handle 4 may rotate locking mechanism 46 to a locked position by rotating inner tube 40 with respect to outer tube 36. Rotation of tube 40 in the opposite direction unlocks mechanism 46.

A shock absorbing structure 60 is disposed inside inner tube 40. Structure 60 has an abutment end 62 against which shoulder 24 abuts when adapter 6 is inserted into handle 4 so that shock forces experienced by tool work head 8 are at least partially transferred to structure 60. Shock absorbing structure 60 may be made from PVC. Shock absorbing structure 60 may be a hollow tube or a solid structure. Structure 60 defines an opening 64 that frictionally receives second shank 22 of adapter 6. Shock absorbing structure 60 may be made from the PVC described above or a plastic, polymer, rubber, or wood material. The materials may be dense or foamed. Structure 60 receives shock forces from adapter and deadens the shock forces so that the user's hands and arms do not absorb all of the forces. As described above, structure 60 abuts expandable locking mechanism 46 and transfers a portion of the shock forces to the expandable locking mechanism 46 which further deadens the forces transferred to the user through the use of shoes 52 having the elastomeric portions.

The combination of the frictional connections between shank 20 and tube 40, the frictional connection between shank 22 and structure 60, and the abutment between shoulder 34 and end 62 provides a tight connection between handle 4 and adapter 6 that prevents tool work head 8 from wobbling with respect to handle 4.

Adapter locking assembly 10 includes inner 70 and outer 72 portions that cooperate to lock adapter 6 to handle 4 and resist rotational movement between adapter 6 and handle 4. Inner portion 70 is secured to the outer surface of inner tube 40 with an adhesive or a mechanical connector. Inner portion 70 includes a grip 74, an intermediate tube 76 having outwardly disposed thread 78, and a plurality of clamping fingers 80 that define an outer cam follower surface 82. Clamping fingers 80 define a rearward-facing ledge. The first end of inner tube 40 abuts the rearward-facing ledge of clamping fingers 80.

Outer portion 72 defines a cup 84 having inwardly disposed thread 86 configured to threadedly engage thread 78. Rotation of outer portion 72 moves outer portion 72 up and down along the length of inner portion 70 as a result of the threaded connection between threads 78 and 86. Outer portion 72 defines a cam 88 disposed to engage cam follower surface 82 when outer portion 72 is moved toward grip 74 of inner portion 70 to force clamping fingers 80 radially inwardly to clamp against first shank 20 of adapter 6. Clamping fingers 80 engage clamping portion 28. Tightening outer portion 72 against inner portion 70 thus locks inner tube 40 to adapter 6.

Handle locking assembly 34 has the same elements as adapter locking assembly 10 and the same reference numerals are used to identify the parts of handle lock assembly 34 in FIG. 3B as FIG. 3A. Clamping fingers 80 of handle locking assembly 34 clamp against the outer surface of inner tube 40. The combination of handle locking assembly 34 and expandable locking mechanism 46 provides a secure connection between outer tube section 30 and inner tube section 32. The two locking points provided by the two locking mechanisms 34 and 46 are spaced apart from one another and work in opposite directions.

An alternate adapter locking assembly 10 is depicted in FIG. 4 wherein a locking pin 100 is used to secure adapter 6 to inner tube 40. Locking pin 100 may be used alone or in combination with adapter locking assembly 10. Locking pin 100 is movable between a locked configuration and an unlocked configuration. When locking pin 100 is in the locked configuration, locking pin 100 extends through inner tube 40 and into a recess 102 defined by first shank 20 of adapter 6. In an alternative configuration, locking pin 100 may extend through inner tube 40 and shock absorbing structure 60 and into a recess defined by second shank 22 of adapter 6. In another configuration, a pair of locking pins 100 may be used in both of these configurations. In the unlocked configuration, locking pin 100 is moved out of recess 102 so that adapter 6 may be removed from handle 4. In the configuration depicted in FIG. 4, first shank 20 is elongated to extend past adapter locking mechanism 10.

In one configuration, a thumb lever 104 is used to allow the user to lift pin 100 out of recess 102. A spring 106 is provided to bias pin 100 downwardly. Spring 106 may be located in a variety of places and provided in a variety of shapes and structures to provide this biasing force. A flat metal V-shaped spring 106 is depicted. A coil spring 106 carried on pin 100 also may be used. Spring 106 provides force that biases locking pin 100 toward recess 102 so that pin 100 will automatically snap into place when recess 102 is aligned with pin 100. Thumb lever 104 is also configured to lift pin 100 out of recess 102 when the user depresses thumb lever 104 toward inner tube 40. These structures may be located in a housing 108.

In another configuration, pin 100 may be used with spring 106 without lever 104. In this configuration, the user pulls directly on pin 100 to remove it from recess 102.

In the foregoing description, certain terms have been used for brevity, clearness, and understanding. No unnecessary limitations are to be implied therefrom beyond the requirement of the prior art because such terms are used for descriptive purposes and are intended to be broadly construed. Moreover, the description and illustration of the invention is an example and the invention is not limited to the exact details shown or described. Throughout the description and claims of this specification the word “comprise” and variations of that word, such as “comprises” and “comprising,” are not intended to exclude additives, components, integers, or steps.

1. A hand tool comprising:
a tool work head;
a tool head adapter having a first shank and a second shank with a shoulder defined between the first and second shanks; the tool head adapter being connected to the tool work head;
a handle having a tool head adapter locking mechanism carried by an inner tube;
a shock absorbing structure disposed inside the inner tube; the shock absorbing structure defining an opening;
the second shank of the adapter disposed in the opening defined by the shock absorbing structure;
at least a portion of the first shank being disposed inside the inner tube;
the shoulder of the adapter abutting the shock absorbing member; and
the tool head adapter locking mechanism having a clamped configuration and an unclamped configuration; a portion of the tool head adapter locking mechanism surrounding a clamping portion of the first shank of the adapter and being clamped against the clamping portion of the first shank of the adapter to secure the tool head adapter to the inner tube.

2. The tool of claim 1, wherein the handle further comprises an outer tube carrying a handle locking mechanism; a portion of the inner tube being disposed in the outer tube.

3. The tool of claim 2, wherein the inner tube carries an expandable locking mechanism; the expandable locking mechanism being disposed inside the outer tube; the expandable locking mechanism having locked and unlocked configurations; the locked configuration of the expandable locking mechanism securing the inner tube to the outer tube.

4. The tool of claim 3, wherein the shock absorbing structure abuts a portion of the expandable locking mechanism.

5. The tool of claim 4, wherein the expandable locking mechanism includes elastomeric portions that engage the outer tube when the expandable locking mechanism is in the locked configuration.

6. The tool of claim 1, wherein the shock absorbing structure is a hollow tube.

7. The tool of claim 6, wherein the hollow tube is fabricated from PVC.

8. The tool of claim 1, wherein the clamping portion of the first shank of the adapter is textured.

9. The tool of claim 1, wherein the tool head adapter locking mechanism includes a locking pin that is biased inwardly toward the tool head adapter; the tool head adapter defining a recess; and a portion of the locking pin being disposed in the recess defined by the tool head adapter to lock the tool head adapter to the inner tube.

10. The tool of claim 9, further comprising a spring that biases the locking pin toward the tool head adapter.

11. The tool of claim 1, wherein the first and second shanks of the adapter are frictionally received by the inner tube and the shock absorbing structure.

12. The tool of claim 1, wherein the tool head adapter locking mechanism includes a first portion connected to the inner tube and a second portion threadedly engaging the first portion; the first portion defining a plurality of clamping fingers engaging the first shank of the tool head adapter.

13. A professional-grade hand tool comprising:
a plurality of tool work heads;
each of the tool work heads being connected to a tool head adapter;
a telescoping handle having a tool head adapter locking mechanism; and
each of the plurality of tool work heads being interchangeably lockable to the telescoping handle with the tool head adapter locking mechanism.

14. The tool of claim 13, wherein each of the tool head adapters includes a first shank and a second shank with a shoulder being defined between the first shank and the second shank.

15. A hand tool comprising:
a tool work head;
a tool head adapter having a first shank and a second shank with a shoulder defined between the first and second shanks; the tool head adapter being connected to the tool work head;
a handle having a tool head adapter locking mechanism carried by an inner tube;
the first and second shanks of the tool head being frictionally received by the handle with the shoulder abutting a portion of the handle; and
the tool head adapter locking mechanism having a clamped configuration and an unclamped configuration; a portion of the tool head adapter locking mechanism surrounding a clamping portion of the first shank of the adapter and being clamped against the clamping portion of the first shank of the adapter to secure the tool head adapter to the inner tube.

16. The tool of claim 15, wherein the handle further comprises an outer tube carrying a handle locking mechanism; a portion of the inner tube being disposed in the outer tube.

17. The tool of claim 16, wherein the inner tube carries an expandable locking mechanism; the expandable locking mechanism being disposed inside the outer tube; the expandable locking mechanism having locked and unlocked configurations; the locked configuration of the expandable locking mechanism securing the inner tube to the outer tube.

18. The tool of claim 17, wherein the expandable locking mechanism includes elastomeric portions that engage the outer tube when the expandable locking mechanism is in the locked configuration.

19. The tool of claim 15, wherein the clamping portion of the first shank of the adapter is textured.

20. The tool of claim 15, wherein the tool head adapter locking mechanism includes a locking pin that is biased inwardly toward the tool head adapter; the tool head adapter defining a recess; and a portion of the locking pin being disposed in the recess defined by the tool head adapter to lock the tool head adapter to the inner tube.
